(19) United States
(12) Patent Application Publication
(10) Pub. No.: US 2008/0184927 A1
(43) Pub. Date: Aug. 7, 2008

(54) Container cap for assuring quality

(76) Inventors: Paul Phong Anh Pham, Woodbine, MD (US); Nina Su Yong Song, Woodbine, MD (US)

Correspondence Address: Leander F. Aulisio, 320 23rd Street #705, Arlington, VA, 22202, US

(21) Appl. No.: 11/701,492

(22) Filed: Feb. 2, 2007

(51) Int. Cl. G01D 21/00

(52) U.S. Cl. 116/207

(57) ABSTRACT

A cap for a container that holds pharmaceutical material, the cap comprising a means of detecting heat and humidity.

### BACKGROUND OF THE INVENTION

The invention relates to a reliable and low cost indicating device that is interfaced with the cap of an over-the-counter drug filled container or a prescription drug filled container. The device is adapted to provide a consumer with a visible warning in the event of catastrophic environmental conditions that affect the potency of the drug. These environmental conditions are related to high temperature and high humidity. Extremely low temperature conditions can also be included within the parameter of catastrophic environmental conditions.

The number of drugs being dispensed by mail order is steadily increasing year after year. Many of these drugs are adapted to be taken internally by the consumer. Accordingly, attempts have been made to provide means by which the consumer can immediately determine if the drugs have been damaged by exposure to high heat conditions and/or high humidity conditions. Presently, the consumer has no viable method of determining the potency of the drugs that he receives through the mail. The consumer is therefore susceptible to damage to his body by taking drugs that are no longer effective for their intended use.

Published Application 2006/0032774, to Norrby et al, relates to a package for goods. The package contains a bar code and a temperature indicator.

Published Application 2004/0154947, to Duranton, relates to a receptacle that contains a single dose of a treatment substance. The receptacle further contains an indicator configured to change state as a function of temperature.

U.S. Pat. No. 6,773,637, issued to DiSalvo et al, relates to a thermochromic temperature sensitive composition. When the temperature is in a certain range, the composition undergoes a color change that is visible to an observer.

U.S. Pat. No. 6,619,494, issued to Brozell et al, relates to a package for tablets having a hold-down device to prevent movement of the tablets.

U.S. Pat. No. 6,043,021, issued to Manico et al, relates to a packaged photographic product containing a silver halide based photographic material cotained within a packaging enclosure and a time and temperature indicating device for providing a visually observable indication of cumulative thermal exposure. The temperature indicating device is removably attached to the packaging enclosure with a pressure sensitive adhesive.

U.S. Pat. No. 5,964,181, issued to Pereyra et al, relates to a temperature indicating device that includes a microporous membrane, an indicating composition containing less than about 10 wt. % water, and a containment means for the indicating composition and the microporous membrane.

U.S. Pat. No. 5,501,945, issued to Kanakkanatt, relates to a method of employing a dye within a polymer. When used with packaging materials, the dye can indicate spoilage or the possibility of spoilage. The dye within a polymer acts as an indicator that a product has been exposed to an undesirably high or low temperature. The dye responds to specific stimuli and indicates exposure to stimuli by a change or shift in the frequencies of light which they absorb. Stimuli include temperature, radiation, chemicals, and tensile or compressive stress.

U.S. Pat. No. 5,085,802, issued to Jalinski, relates to a time-temperature indicator having a distinct end-point. The preferred dynamic indicator system generates a constant pH buffer in the alkali range that is maintained until one of the substrates is depleted. At that time, a rapid pH change in the indicator solution to the acid range occurs. A very sharp visual color change appears in the pH sensitive dye. An enzyme/substrate pair is disclosed as the dynamic indicator system.

U.S. Pat. No. 4,917,503, issued to Bhattacharjee, relates to a photoactive leuco base time-temperature indicator. The indicator is useful for monitoring the freshness of perishable products.

U.S. Pat. No. 4,533,640, issued to Shafer, relates to an adjustable accumulated thermal exposure indicator device. The device includes a reactant yielding material that provides an amine at a specific rate depending on time, temperature and pH. The device further includes an indicator that reacts at a time, temperature, concentration and pH dependent rate with the amine to produce a visible reaction product. The appearance of a visual color coincides with the end of the useful life of the product to which the device is affixed.

U.S. Pat. No. 4,432,656, issued to Allmendinger, relates to an indicator for providing a time/temperature integrated indication of the temperature history of a deep-frozen product through the diffusion of water through a cellulosic wick. The wick is covered in a plastic covering with an opening in the covering exposing the wick to water.

U.S. Pat. No. 4,432,462, issued to Newkirk, relates to a reliable and low cost indicator for use with receptacle filled with over-the-counter drug. The tampering indicator is preferably attached to the underside of a removable receptacle cap. The tampering indicator includes a fluid filled reservoir, a tab having a chemically treated indicator strip, and a fluid path by which fluid from the reservoir communicates with the indicator strip. The tab and indicator strip thereof extend outwardly from beneath the cap of the receptacle for providing the consumer with a visual indication in the event of unauthorized removal of the cap from the receptacle.

The above prior art refuses to indicate or suggest, either individually or in combination, the novel concept of the present invention. None of the prior art suggests the advancement in the art that is indicated by the following presentation of the present inventive concept. There is a need for a method for consumers to know whether the drugs they receive in the mail are full of potency or if they have been damaged in transit.

### SUMMARY OF THE INVENTION

The invention relates to a reliable and low cost temperature and humidity indicator that is configured as a removable cap that fits on a standard cylindrical container or receptacle for receiving over-the-counter drugs or prescription drugs. The cap is fitted with an indicator device that allows merchants or consumers to immediately identify pharmaceutical compositions that are of unacceptable quality due to overexposure to heat and humidity.

The invention further relates to a reliable and low cost temperature and humidity indicator that is configured as an attachment on a medical box that contains pharmaceutical materials, the medical box being useful for personnel in an ambulance. The indicator device allows EMS personnel to immediately identify pharmaceutical compositions that are of unacceptable quality due to overexposure to heat and humidity.

### BRIEF DESCRIPTION OF THE FIGURES

FIG. 1 is a representative drawing of a standard pill bottle for containing a supply of pills of either an over-the-counter drug or a prescription drug. The pill bottle is closed at its open end with a removable screw-type cap, the cap included an indicator means on its underside.

FIG. 2 is a representation of an exploded view of a cap of the present invention. The cap is a screw-on cap, and contains a sensor means and a protective layer.

### DETAILED DESCRIPTION OF THE INVENTION

A pharmaceutical device is hereby disclosed. The device comprises a cylindrical container having a closed end (bottom) and an open end (top). The cylindrical container is employed for receiving a pharmaceutically active material. A removable mating circular cap for closing said container is also disclosed. The device further comprises an indicator device for providing visually observable indication of cumulative thermal exposure and humidity exposure. An attachment means is employed for connecting the indicator device to the underside of the removable cap. A consumer is quickly and easily warned if the pharmaceutically active material has been exposed to heat and humidity that is outside the range recommended by the manufacturer of the pharmaceutically active material. The device further comprises the pharmaceutically active material that is received in the container.

The pharmaceutical device further comprises a barrier layer positioned between the indicator device and the pharmaceutically active material enclosed within the container. Preferably, the barrier layer is directly attached to the underside of the cap. The barrier layer effectively prevents contamination of the active by indicator material. The barrier layer effectively covers the indicator device. The barrier layer is prepared from materials commonly employed in the art, and as such forms no part of the present invention. Examples of materials useful as barrier layers for the present invention are: silicones, acrylates, PET (polyethylene terephthalate), polyethylene and the like. Broadly, the barrier layer is member selected from the group consisting of a synthetic polymer, a natural polymer and a paper product.

The pharmaceutically active material is a member selected from the group consisting of a synthetic drug, a vitamin, a natural herbal product, a natural drug, and an inorganic mineral. Examples of pharmaceutically active materials are: an HIV retroviral drug, a cholesterol lowering drug, a blood pressure lowering drug, a drug for control of diabetes, an analgesic drug, a cardiovascular drug and an anti-bacterial drug.

The indicator device is a member selected from the group consisting of a litmus paper, a holographic element, a RFID (radiofrequency indicator device), and a chemical dye. Any indicator device that can readily reveal environmental changes in temperature and humidity can be employed in the present invention. Preferably, the indicator device is in solid form and is integral with the cap. By “integral with the cap” is meant that the indicator device is substantially part of the cap. The cap comprises an indicator device for providing visually observable indication of cumulative thermal exposure and humidity exposure.

The container is a member selected from the group consisting of a plastic bottle, a glass bottle and a paper product container. In a preferred embodiment, the container is a plastic bottle. Most preferably, the plastic bottle is fitted with a cap that is a member selected from the group consisting of a screw-type cap and a snap-on cap. The cap is fitted with an indicator device by an attachment means. The attachment means is a member selected from the group consisting of an adhesive composition, a tape material, a clip arrangement and a snap-on configuration. The attachment means is preferably located on the underside of the cap

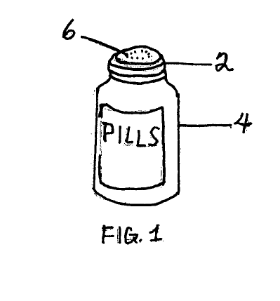

Referring to FIG. 1, a substantially cylindrical container 4 for receiving pills is depicted. The container 4 is fitted with a screw-type cap 2 that contains an indicator device 6 on the underside of the cap 2. In an alternative embodiment, the cap 2 can be a snap-on cap rather than a screw-type cap. Preferably, the cap 2 can be a member selected from the group consisting of a child-proof cap, an easy-open cap for the elderly and a regular cap for average adults.

The indicator device 6 can be attached to the underside of the cap 2 as by an attachment means, not shown. Also, a barrier layer, not shown, can be positioned between the indicator device 6 and the pills, not shown, stored in container 4. The barrier layer can be attached to the barrier layer as by adhesive means, not shown. Alternatively, both the indicator device 6 and the barrier layer can be positioned inside the cap 2 by manufacturing said indicator device 6 and barrier layer such that they snugly fit into the cap, thereby avoiding the need for attachment means. The barrier layer prevents contamination of the stored pills by the indicator device, and hence said barrier layer must be inert with regard to the pills. Preferably, the pills are pharmaceutical drugs or vitamins. The pills can also be nutritional supplements, diet pills or the like.

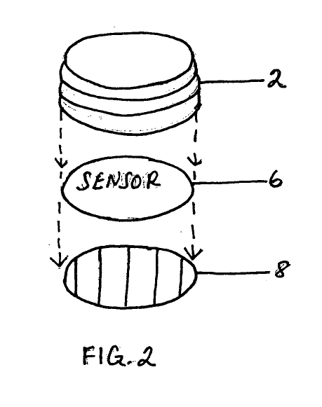

Referring to FIG. 2, a substantially cylindrical cap 2 is depicted. The cap 2 contains on its underside an indicator device 6 and a barrier layer 8. The barrier layer 8 is preferably made of a material that is inert with respect to material contained within a container for use with cap 2. The barrier layer 8 completely covers the indicator device 6, thereby protecting the material within the container from contamination by said device 6. The indicator device 6 is secured to the underside of cap 2 as by an attachment means, not shown. Alternatively, the indicator device 6 can be manufactured to snugly fit into the cap 2, thereby eliminating the need for attachment means. Similarly, the barrier layer 8 can be secured to the indicator device 6 as by an attachment means, not shown. The barrier layer 8 can be, in the alternative, manufactured to snugly fit into the cap 2, thus eliminating the need for any attachment means. Attachment means for both the indicator device 6 and the barrier layer 8 can be a member selected from the group consisting of an adhesive composition, a tape material, a clip arrangement and a snap-on configuration on the underside of the cap.

While the invention has been described by specific examples and embodiment, there is no intent to limit the inventive concept except as set forth in the following claims.

We claim:

1. A pharmaceutical device comprising:
(a) a container for receiving a pharmaceutically active material;
(b) a removable mating cap for closing said container;
(c) an indicator device for providing visually observable indication of cumulative thermal exposure and cumulative humidity exposure; and
(d) attachment means for connecting the indicator device to the underside of the removable cap, whereby a consumer is quickly and easily warned if the pharmaceutically active material has been exposed to heat and humidity that is outside the range recommended by the manufacturer of the pharmaceutically active material.

2. A pharmaceutical device according to claim 1 further comprising the pharmaceutically active material that is received in the container.

3. A pharmaceutical device according to claim 2 further comprising a barrier layer positioned between the indicator device and the pharmaceutically active material that is within the container.

4. A pharmaceutical device according to claim 3 wherein the barrier layer is directly attached to the underside of the cap.

5. A pharmaceutical device according to claim 2 wherein the pharmaceutically active material is a member selected from the group consisting of a synthetic drug, a vitamin, a natural herbal product, a natural drug, and an inorganic mineral.

6. A pharmaceutical device according to claim 1 wherein the synthetic drug is a member selected from the group consisting of an HIV retroviral drug, a cholesterol lowering drug, a blood pressure lowering drug, a drug for control of diabetes, an analgesic drug, a cardiovascular drug, an anti-bacterial drug, a drug for treatment of arthritis, and a drug for treatment of asthma.

7. A pharmaceutical device according to claim 1 wherein the indicator device is a member selected from the group consisting of a litmus paper, a holographic element, a RFID (radiofrequency indicator device), a chemical dye, a thermochromic pigment and a liquid crystal material.

8. A pharmaceutical device according to claim 1 wherein the container is a member selected from the group consisting of a plastic bottle, a glass bottle, a metal bottle and a paper product container.

9. A pharmaceutical device according to claim 1 wherein the attachment means is a member selected from the group consisting of an adhesive composition, a tape material, a clip arrangement and a snap-on configuration on the underside of the cap.

10. A pharmaceutical product according to claim 3 wherein the barrier layer is member selected from the group consisting of a synthetic polymer, a natural polymer, a paper product and a metal foil.

11. A mating removable cap for a container that encloses a pharmaceutically active material, the cap comprising an indicator device for providing visually observable indication of cumulative thermal exposure and humidity exposure.

12. A removable cap according to claim 11 wherein the indicator device is integral with the cap.

13. A removable cap according to claim 11 wherein the indicator device is connected to the cap with an attachment means.

14. A removable cap according to claim 13 wherein the attachment means is a member selected from the group consisting of an adhesive composition, a tape material, a clip arrangement and a snap-on configuration on the underside of the cap.

15. A removable cap according to claim 11 further comprising a barrier layer that covers the indicator device.

16. A removable cap according to claim 11 wherein the indicator device is a member selected from the group consisting of a litmus paper, a holographic element, a RFID (radiofrequency indicator device), a chemical dye, a thermochromic pigment and a liquid crystal material.

17. A reliable and low cost temperature and humidity indicator that is configured as an attachment on a medical box that contains pharmaceutical materials, the medical box being useful for personnel in an ambulance.
